(19) United States
(12) Patent Application Publication
(10) Pub. No.: US 2010/0090969 A1
(43) Pub. Date: Apr. 15, 2010

(54) ELECTRONIC DEVICE WITH INFRARED TOUCH INPUT FUNCTION

(75) Inventors: XIN ZHAO, Shenzhen City (CN); ZU-PEI HE, Shenzhen City (CN); RUEY-SHYANG YOU, Tu-Cheng (TW); HUA-DONG CHENG, Shenzhen City (CN); HAN-CHE WANG, Tu-Cheng (TW); KUAN-HONG HSIEH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/545,873

(22) Filed: Aug. 24, 2009

(30) Foreign Application Priority Data
Oct. 13, 2008 (CN) 200810304897.1

(51) Int. Cl. G06F 3/041

(52) U.S. Cl. 345/173

(57) ABSTRACT

An electronic device with infrared touch input function is provided. The electronic device includes a display unit including two pairs of oppositely disposed sides defining an information display area; an infrared input device including a circuit board having two pairs of oppositely disposed sides defining an open area corresponding in size and shape to the information display area, a linear array of light emitting devices positioned on one side or two adjacent sides of the circuit board, configured for emitting infrared light; a micro-processing unit configured for generating control signals to control a corresponding light emitting device to emit infrared light, and determining whether the light detecting device receives the infrared light; and a central processing unit configured for controlling the display unit displaying a plurality of menu options determining whether the menu option is touched; and performing functions corresponding to the menu option when the menu option is touched.

### RELATED APPLICATIONS

This application is related to copending applications entitled, “ELECTRONIC DEVICE WITH INFRARED TOUCH INPUT FUNCTION”, filed ______ (Atty. Docket No. US 23305); “ELECTRONIC DEVICE WITH INFRARED TOUCH INPUT FUNCTION”, filed ______ (Atty. Docket No. US23308); and “ELECTRONIC DEVICE WITH INFRARED TOUCH INPUT FUNCTION”, filed ______ (Atty. Docket No. US24653).

### BACKGROUND

1. Technical Field

The disclosure relates to an infrared touch input device for use with an information display system, more particularly, relates to an electronic device with infrared touch input function.

2. General Background

It is already known that an infrared input system comprises a circuit board having a first pair of opposed sides positioned parallel to a first axis and a second pair of opposed sides positioned parallel to a second axis, the second axis being perpendicular to the first axis, each of the second pair of sides connecting the first pair of sides, all four sides defining a generally rectangular touch input area, a linear array of light emitting devices along each side, and a light detection device positioned at each corner of the circuit board; and a controller coupled to the light emitting devices and the light detection devices, therein the controller sequentially activates each linear array and activates the light detection devices positioned at corners of the circuit board opposed to the activated array of light emitting devices. The system can discern the location of a touch within the information display area by implementing an algorithm on x, y coordinates detected by the detectors, which is complicated and time consuming.

Therefore, it is necessary to provide a electronic device with infrared touch input function to implement the functions easier.

### BRIEF DESCRIPTION OF THE DRAWINGS

FIG. 1 is an exploded view showing an electronic device with an infrared touch input function in accordance with a first exemplary embodiment.

FIG. 2 is a schematic diagram showing the electronic device of FIG. 1.

FIG. 3 is a block diagram showing an internal configuration of the electronic device of FIG. 1.

FIG. 4 is a flowchart implemented by the electronic device of FIG. 2 in one circular scan.

FIG. 5 is a schematic diagram showing another electronic device with an infrared touch input function in accordance with a second exemplary embodiment.

FIG. 6 is a block diagram showing the internal configuration of the electronic device of FIG. 5.

### DETAILED DESCRIPTION

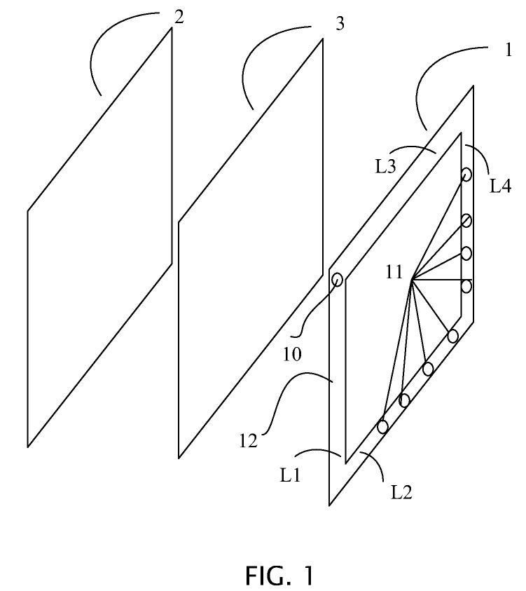

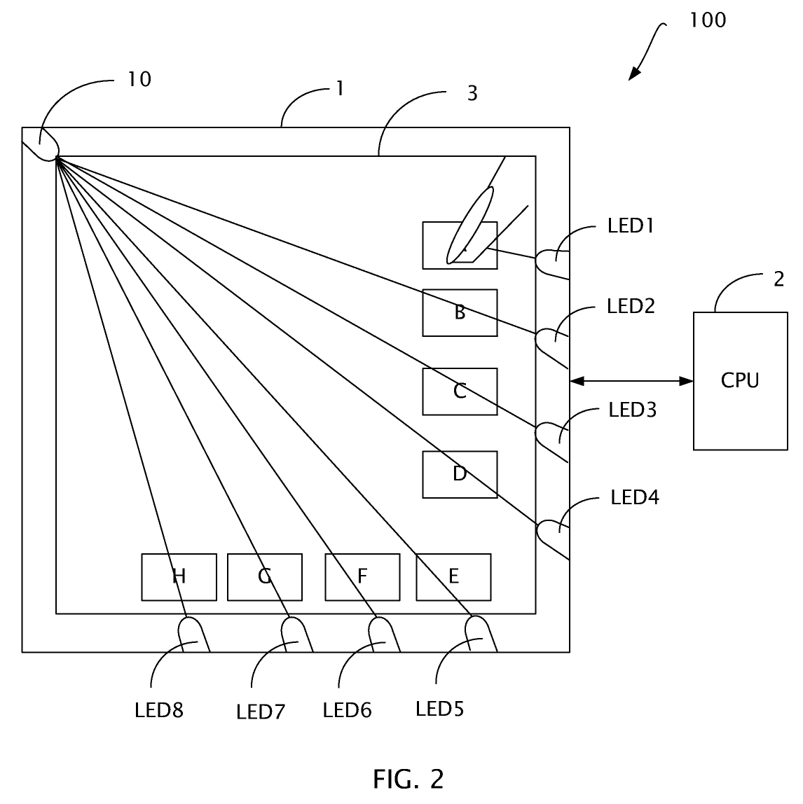

FIG. 1 is an exploded view showing an electronic device with an infrared touch input function in accordance with a first exemplary embodiment. FIG. 2 is a schematic diagram showing the electronic device of FIG. 1. The electronic device 100 includes an infrared input device 1, a central processing unit (CPU) 2, and a display unit 3.

The CPU 2 is electronically connected to the infrared input device 1 and the display unit 3. The display unit 3 may be a flat panel display having two pairs of oppositely disposed sides defining an information display area. The infrared input device 1 may include a circuit board 12 having two pairs of oppositely disposed sides defining an open area corresponding in size and shape to the information display area. The circuit board 12 includes at least one light detecting device 10 and a linear array of light emitting devices 11 (LED1-LED8).

In an exemplary embodiment, the light detecting devices 10 are infrared phototransistors, the light emitting devices 11 are organic light emitting diodes that emit light in the infrared (IR) range. The light emitting devices 11 can be positioned on one side or two adjacent sides of the circuit board 12. The light detecting device 10 is positioned at one corner of the circuit board 12 and faces the light emitting devices 11 for detecting infrared light emitted by the light emitting devices 11. For example, in the exemplary embodiment, the light detecting device 10 is positioned at the top right corner of the circuit board 12.

The CPU 2 is configured to control the display unit 3 to display a plurality of menu options corresponding to the light emitting devices 11. The number of the menu options displayed will be the same as the number of the light emitting devices 11. As shown in FIG. 2, there are 8 menu options A-H respectively corresponding to LED1-LED8. When one menu option is touched by a user, an infrared light path between the light detecting device 10 and the corresponding light emitting device 11 is obstructed, as a result, the light detecting device 10 does not detect the infrared light emitted by the corresponding light emitting device 11. The CPU 2 is configured to determine the menu option touched by the user when the light detecting device 10 detects an interruption of the infrared light emitted by the corresponding light emitting device 11 and thereby performs a function corresponding to the menu option.

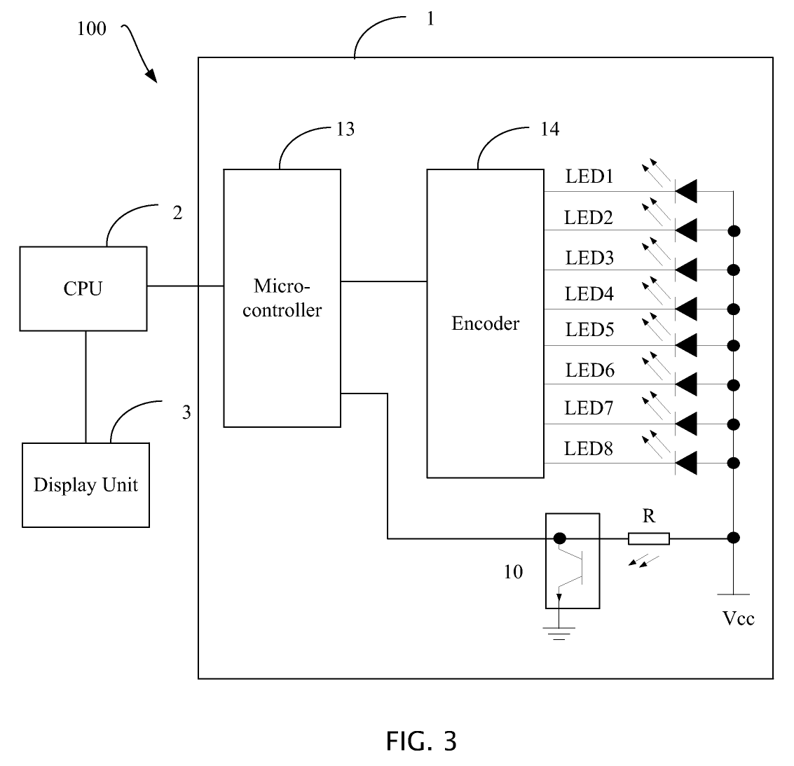

FIG. 3 is a block diagram showing the internal configuration of the electronic device 1. The infrared input device 1 further includes a micro-controller 13 and an encoder 14 connected to the micro-controller 13. The micro-controller 13 is further connected to the light detecting device 10 and the CPU 2. The light detecting device 10 is further connected to a voltage source Vcc and ground. Outputs of the encoder 14 are correspondingly connected to the cathodes of the light emitting devices 11. The anodes of all light emitting devices 11 are commonly connected to the voltage source Vcc. The micro-controller 13 is configured to generate control signals to the encoder 14. The encoder 14 is configured to control the corresponding light emitting devices 11 to emit infrared light according to the control signals. The control signals may be repeatedly changed in a defined sequence, such as 000, 001, 010, 011, 100, 101, 110 and 111 respectively corresponding to controlling the emitting of LEDs1-8.

Taking the control signal 000 as an example, the encoder 14 will control the LED1 to emit infrared light. If the infrared light path between the LED 1 and the light detecting device 10 is not obstructed, the light detecting device 10 will be controlled to send a low voltage to the micro-controller 13. If the infrared light path between the LED 1 and the light detecting device 10 is obstructed blocking the light emitted by the LED 1, the light detecting device 10 will be controlled to send a high voltage to the micro-controller 13. The micro-controller 13 is further configured to determine the menu option touched by the user when the high voltage is received.

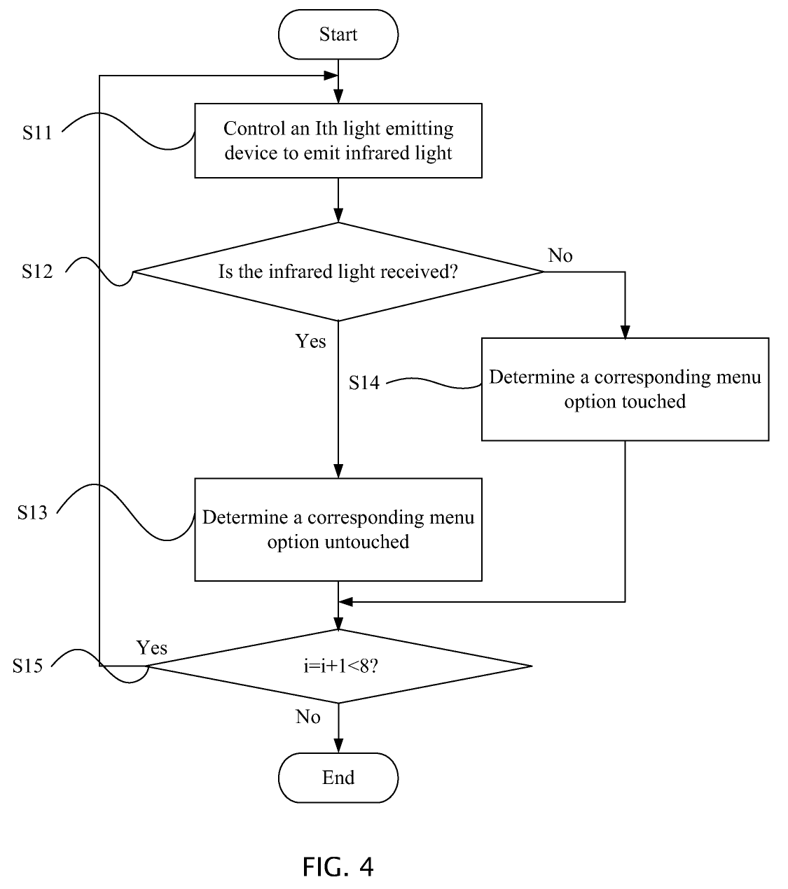

FIG. 4 is a flowchart implemented by the electronic device 1 in accordance with the first exemplary embodiment. The flowchart shows one circular scan, scanning from LED1 to LED8.

In step S11, the encoder 14 controls the Ith light emitting device 11 to emit infrared light. In the exemplary embodiment, the encoder 14 controls the light emitting devices 11 to emit infrared light according to a predetermined sequence. For example, the encoder 14 controls the light emitting devices 11 one by one from LED1 to LED8. In step S12, the micro-processor 13 determines whether the infrared light is received. If yes, the procedure goes to step S13, otherwise, the procedure goes to S14. In step S13, the micro-processor 13 determines the corresponding menu option is not touched, and the procedure goes to S15. In step S14, the micro-processor 13 determines the corresponding menu option is touched by the user, and sends the high voltage to the CPU 2. The CPU 2 performs functions corresponding to the menu option being touched according to the signal, and the procedure goes to S15. In step S15, the micro-processor 13 determines whether I+1 is less than or equal to the total number of the light emitting devices 11, e.g., 8. If yes, the procedure goes to step S11, otherwise, the procedure ends.

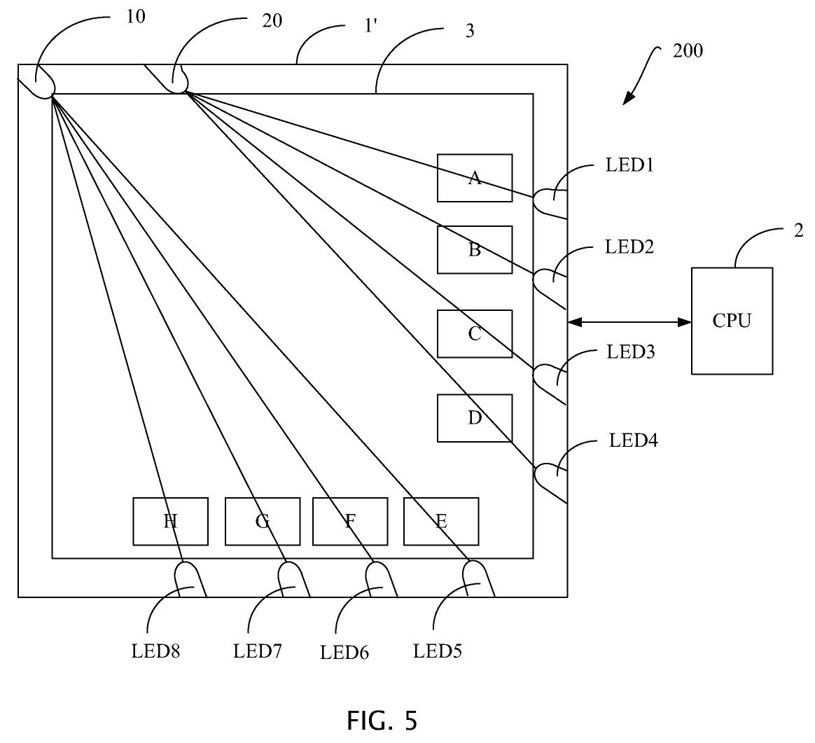

FIG. 5 is a schematic diagram showing an electronic device 1′ in accordance with a second exemplary embodiment. The difference from the first exemplary embodiment, there are two light detecting devices 10 and 20 positioned on the circuit board 12, the light detecting device 10 is at one corner of the circuit board 12 for detecting infrared light emitted by LED5-LED8, and the light detecting device 20 is near the light detecting device 10 for detecting infrared light emitted by LED1-LED4.

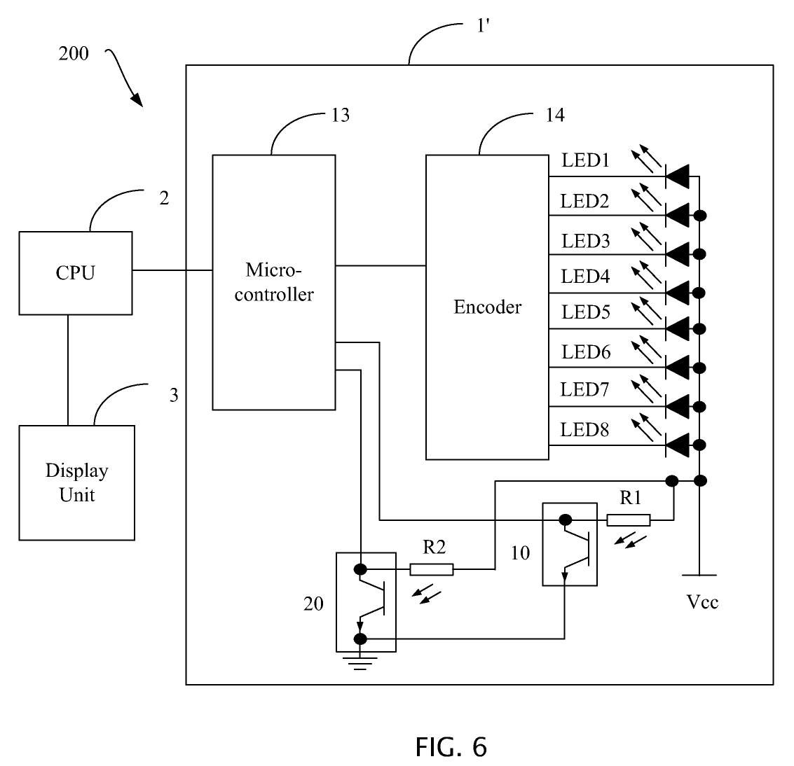

FIG. 6 is a block diagram showing the internal configuration of the electronic device 1′. The difference between FIG. 5 and FIG. 2 is that, the anodes of LED1-LED 4 are commonly connected to the voltage source Vcc and the light detecting device 10, and the anodes of LED5-LED 8 are commonly connected to the voltage source Vcc and the light detecting device 20.

In order to avoid misoperation, in one scan, only when the time of the infrared light that is not received by the light detecting device 10 lasts for a predetermined time, the micro-processor 13 sends the high voltage to the CPU 2 to perform the functions corresponding to the menu option. Alternatively, during one circular scan, the micro-processor 13 detects the infrared light from one light emitting device 11 is not received by the light detecting device 10, and in the next one or two successive circular scans, the micro-processor 13 detects the infrared light from the same light emitting device 11 is still not received, the micro-processor 13 sends the high voltage to the CPU 2 to perform the functions corresponding to the menu option.

Although the present disclosure has been specifically described on the basis of an exemplary embodiment thereof, the disclosure is not to be construed as being limited thereto. Various changes or modifications may be made to the embodiments without departing from the scope and spirit of the disclosure.

What is claimed is:

1. An electronic device with infrared touch input function, comprising:
a display unit comprising two pairs of oppositely disposed sides defining an information display area;
an infrared input device comprising a circuit board having two pairs of oppositely disposed sides defining an open area corresponding in size and shape to the information display area,
a linear array of light emitting devices positioned on one side or two adjacent sides of the circuit board, configured for emitting infrared light;
at least one light detecting device positioned on one corner of the circuit board and faced to light emitting devices, configured for detecting infrared light emitted by the light emitting devices; and
a micro-processing unit configured for generating control signals to control a corresponding light emitting device to emit infrared light, and determining whether the light detecting device receives the infrared light; and
a central processing unit (CPU) electronically connected with an infrared input device and the display unit, configured for controlling the display unit displaying a plurality of menu options corresponding to light emitting devices, determining whether the menu option is touched by determining whether the light detecting device receives the infrared light; and performing functions corresponding to the menu option when the menu option is touched.

2. The electronic device as claimed in claim 1, further comprising an encoder electronically connected between the light emitting devices and the micro-processor, configured for controlling the corresponding light emitting device to emit infrared light according to the control signals generated by the micro-processor, and sending a high voltage to the micro-processor when the light emitting device receives the infrared light.

3. The electronic device as claimed in claim 1, wherein the display unit is a flat panel display.

4. The electronic device as claimed in claim 1, wherein the light detecting device is an infrared phototransistor.

5. The electronic device as claimed in claim 1, wherein the light emitting device is an organic light emitting diode.

6. The electronic device as claimed in claim 1, wherein the micro-processor sends a high voltage to the CPU to perform the functions corresponding to the menu option when a time of the infrared light that is not received by the light detecting device lasts for a predetermined time in one circular scan.

7. The electronic device as claimed in claim 1, wherein the micro-processor sends a high voltage to the CPU to perform the functions corresponding to the menu option, when the micro-processor detects the infrared light from the same light emitting device is not received by the light detecting device in next one or two successive circular scans.

8. A method of controlling an electronic device with infrared touch input function, the electronic device comprising:
a display unit comprising two pairs of oppositely disposed sides defining an information display area;
an infrared input device comprising a circuit board having two pairs of oppositely disposed sides defining an open area corresponding in size and shape to the information display area;
a linear array of light emitting devices positioned on one side or two adjacent sides of the circuit board, configured for emitting infrared light;
at least one light detecting device positioned on one corner of the circuit board and faced to light emitting devices, configured for detecting infrared light emitted by the light emitting devices;
a micro-processing unit configured for generating control signals to control a corresponding light emitting device to emit infrared light, and determining whether the light detecting device receives the infrared light;
the method comprising:
controlling the display unit displaying a plurality of menu options corresponding to light emitting devices,
determining whether the menu option is touched by determining whether the light detecting device receives the infrared light; and
performing functions corresponding to the menu option when the menu option is touched.

9. The method of controlling an electronic device according to claim 8, wherein the electronic device further comprises an encoder electronically connected between the light emitting devices and the micro-processor, configured for controlling the corresponding light emitting device to emit infrared light according to the control signals generated by the micro-processor, and sending a high voltage to the micro-processor when the light detecting device receives the infrared light.

10. The method of controlling an electronic device according to claim 8, comprising: the micro-processor sending a high voltage to the CPU to perform the functions corresponding to the menu option when a time of the infrared light that is not received by the light detecting device lasts for a predetermined time in one circular scan.

11. The method of controlling an electronic device according to claim 8, comprising: the micro-processor sending a high voltage to the CPU to perform the functions corresponding to the menu option, when the micro-processor detects the infrared light from the same light emitting device is not received by the light detecting device in next one or two successive circular scans.

12. A method of controlling an electronic device with infrared touch input function, comprising:
controlling an Ith light emitting device to emit infrared light;
determining whether the infrared light is received;
determining a corresponding menu option is touched when the infrared light is not received; and
performing functions corresponding to the menu option being touched according to the signal.

13. The method of controlling an electronic device according to claim 12, comprising determining the corresponding menu option is not touched when the infrared light is received.

14. The method of controlling an electronic device according to claim 12, comprising:
determining whether I+1 is less than or equal to 8;
starting a new circular scan if the I+1 is equal to 8; or
controlling an (I+1)th light emitting device to emit infrared light if the I+1 is less than 8.

15. The method of controlling an electronic device according to claim 12, comprising performing the functions corresponding to the menu option when a time of the infrared light that is not received by the light detecting device lasts for a predetermined time in one circular scan.

16. The method of controlling an electronic device according to claim 12, comprising performing the functions corresponding to the menu option, when the micro-processor detects the infrared light from the same light emitting device is not received by the light detecting device in next one or two successive circular scans.
